(19) United States
(12) Patent Application Publication
(10) Pub. No.: US 2024/0361896 A1
(43) Pub. Date: Oct. 31, 2024

(54) PORTABLE DISPLAY DEVICE

(71) Applicant: Samsung Display Co., LTD., Yongin-si (KR)

(72) Inventors: Che Ryong HWANG, Yongin-si (KR); Doo Hwan KIM, Yongin-si (KR); Yong Eun PARK, Yongin-si (KR); Sun Jung YOON, Yongin-si (KR); Kyeong Geun LEE, Yongin-si (KR); Yun Joo YIM, Yongin-si (KR); Sun Ho CHA, Yongin-si (KR)

(21) Appl. No.: 18/399,603

(22) Filed: Dec. 28, 2023

(30) Foreign Application Priority Data
Apr. 28, 2023 (KR) 10-2023-0056379

(51) Int. Cl. G06F 3/04847; G06F 3/041; G06F 3/044

(52) U.S. Cl. CPC G06F 3/04847; G06F 3/0412; G06F 3/0416; G06F 3/0446

(57) ABSTRACT

A portable display device includes a display panel displaying an image with pixels of a display area, a touch sensor disposed in a front surface direction of the display area and a non-display area of the display panel, a touch driving circuit driving touch electrodes of the touch sensor to detect a touch occurrence position of at least one point, a touch movement direction, and a movement distance and generating touch coordinate data according to a detection result, and a display driving circuit displaying an icon or a menu bar in the display area so that a user controls a screen control function and an operation control function of the display panel according to the touch occurrence position of the at least one point, the touch movement direction, and the movement distance.

This application claims priority to Korean Patent Application No. 10-2023-0056379, filed on Apr. 28, 2023, and all the benefits accruing therefrom under 35 U.S.C. § 119, the content of which in its entirety is herein incorporated by reference.

### BACKGROUND

### 1. Field

The disclosure relates to a portable display device.

### 2. Description of the Related Art

An importance of display devices is being increased with a development of multimedia. Accordingly, various types of display devices such as organic light-emitting displays (“OLEDs”) and liquid crystal displays (“LCDs”) are being used.

Recently, when a user uses a display device, a method of providing mobility is being an important issue. In particular, recently, various portable display devices having performance comparable to that of desktop computers as well as mobile phones are being sold.

Due to a reduction in size and weight of the portable display devices, users perform various functions such as a function of viewing an image and a function of running an office program while moving, in addition to basic data transmission and reception functions. Accordingly, the users should be able to more conveniently and accurately control the portable display devices.

Recently, the portable display devices include various sensors to perform corresponding operations according to user's control operations. Recently, with the development of technology, a degree of user's operation recognition and sensitivity of sensors further increase, and thus, performance improvement of interface functions of the display devices is further demanded.

### SUMMARY

Features of the disclosure provide a portable display device capable of improving a user interface function by displaying icons, menu bars, or the like, capable of selecting or controlling built-in functions according to a user's touch position and touch operation.

Features of the disclosure also provide a portable display device capable of controlling predetermined built-in functions with only a one-touch movement operation according to a user's touch position.

However, features of the disclosure are not restricted to those set forth herein. The above and other features of the disclosure will become more apparent to one of ordinary skill in the art to which the disclosure pertains by referencing the detailed description of the disclosure given below.

In an embodiment of the disclosure, a portable display device includes a display panel displaying an image with pixels of a display area, a touch sensor disposed in a front surface direction of the display area and a non-display area of the display panel, a touch driving circuit driving touch electrodes of the touch sensor to detect a touch occurrence position of at least one point, a touch movement direction, and a movement distance and generating touch coordinate data according to a detection result, and a display driving circuit displaying an icon or a menu bar in the display area so that a user controls a screen control function and an operation control function of the display panel according to the touch occurrence position of the at least one point, the touch movement direction, and the movement distance.

In an embodiment, the display driving circuit divides a touch sensing area of the touch sensor into a plurality of peripheral areas, a plurality of divided areas, and a central divided area based on arrangement coordinates of touch nodes arranged in a matrix form in the touch sensing area, and compares touch coordinates of the touch coordinate data with the arrangement coordinates of the touch nodes and divides the touch occurrence position of the at least one point, the touch movement direction, and the movement distance for each of the plurality of peripheral areas, the plurality of divided areas, and the central divided area.

In an embodiment, the display driving circuit generates digital video data including the icon or the menu bar so that the user confirms and controls at least one screen control function of brightness, chromaticity, resolution, and contrast control functions and at least one operation control function of volume, power, and mute control functions so as to correspond to the touch occurrence position of the at least one point, the touch movement direction, and the movement distance divided for each of the plurality of peripheral areas, the plurality of divided areas, and the central divided area, and controls the screen control function or the operation control function according to the touch occurrence position of the at least one point, the touch movement direction, and the movement distance changed in real time.

In an embodiment, the display driving circuit divides an area included in an arrangement range of a touch node of a coordinate point (X(m+a), Y(n)), a touch node of a coordinate point (X(m+a), Y(m+a)), and a touch node of a coordinate point (X(m), Y(m+a)) based on a touch node of a coordinate point (X(m), Y(n)) along an outer edge of the touch sensing area in one direction as a first peripheral area, divides an area included in an arrangement range of the touch node of the coordinate point (X(m), Y(m+a)), a touch node of a coordinate point (X(n−a), Y(m+a)), and a touch node of a coordinate point (X(n−a), Y(m)) based on a touch node of a coordinate point (X(m), Y(m)) along an outer edge of the touch sensing area in a lower direction as a second peripheral area, divides an area included in an arrangement range of the touch node of the coordinate point (X(n−a), Y(m)), a touch node of a coordinate point (X(n−a), Y(n−a)), and a touch node of a coordinate point (X(n), Y(n−a)) based on a touch node of a coordinate point (X(n), Y(m)) along an outer edge of the touch sensing area in another direction as a third peripheral area, and divides an area included in an arrangement range of the touch node of the coordinate point (X(n), Y(n−a)), a touch node of a coordinate point (X(m+a), Y(n−a)), and the touch node of the coordinate point (X(m+a), Y(n)) based on a touch node of a coordinate point (X(n), Y(n)) along an outer edge of the touch sensing area in an upper direction as a fourth peripheral area, the first to fourth peripheral areas are divided in a preset bezel area or an area corresponding to or overlapping the non-display area, and m is 0 or a positive integer greater than 0, a is a positive integer greater than m, and n is a positive integer greater than a.

In an embodiment, the display driving circuit divides first to fourth peripheral areas by dividing arrangement coordinates of the touch nodes each disposed in outer areas having a preset size in one direction, a lower direction, another direction, and an upper direction of the touch sensing area, divides first to fourth divided areas in first to fourth corner directions according to arrangement positions of corner arrangement coordinates in four directions that do not overlap the first to fourth peripheral areas, and divides a central area of the touch sensing area into the central divided area which does not overlap the first to fourth divided areas, and the first to fourth peripheral areas are divided in a preset bezel area or an area corresponding to or overlapping the non-display area.

In an embodiment, the display driving circuit decides the touch occurrence position, the touch movement direction, and the movement distance for each of the first to fourth peripheral areas, the first to fourth divided areas, and the central divided area according to a comparison result between divided arrangement coordinates of the touch nodes and the touch coordinates of the touch coordinate data which is input in real time.

In an embodiment, when a touch occurrence position of one point is detected in any one of the first to fourth peripheral areas and the touch occurrence position of the one point moves in preset Y-axis and −Y-axis directions or preset X-axis and −X-axis directions according to the comparison result between the arrangement coordinates of the touch nodes and the touch coordinates which are input in real time, the display driving circuit may generate digital video data so as to include an icon displaying any one screen control function selected among first to fourth screen control functions preset for each of the first to fourth peripheral areas and displays the digital video data as an image, and execute the selected one screen control function according to the touch occurrence position of the one point, the touch movement direction, and the movement distance.

In an embodiment, when touch occurrence positions of two points are detected in any one of the first to fourth divided areas and the touch occurrence positions of the two points move in any one of Y-axis and −Y-axis directions and X-axis and −X-axis directions according to the comparison result between the arrangement coordinates of the touch nodes and the touch coordinates which are input in real time, the display driving circuit may generate digital video data so as to include a menu bar displaying any one operation control function selected among first to fourth operation control functions preset for each of the first to fourth divided areas and displays the digital video data as an image, and execute the selected one operation control function according to the touch occurrence positions of the two points, the touch movement direction, and the movement distance.

In an embodiment, when touch occurrence positions of two points are detected in the central divided area and the touch occurrence positions of the two points move in any one of Y-axis and −Y-axis directions and X-axis and −X-axis directions according to the comparison result between the arrangement coordinates of the touch nodes and the touch coordinates which are input in real time, the display driving circuit may generate digital video data so as to include a menu bar display a preset operation control function based on a two-point touch of the central divided area and displays the digital video data as an image, and execute the preset operation control function based on the two-point touch of the central divided area according to the touch occurrence positions of the two points, the touch movement direction, and the movement distance.

In an embodiment, when touch occurrence positions of three points are detected in any one of the first to fourth divided areas and the touch occurrence positions of the three points move in any one of Y-axis and −Y-axis directions and X-axis and −X-axis directions according to the comparison result between the arrangement coordinates of the touch nodes and the touch coordinates which are input in real time, the display driving circuit may generate digital video data so as to include a menu bar displaying any one operation control function selected among fifth to eighth operation control functions preset for each of the first to fourth divided areas and displays the digital video data as an image, and execute the selected one operation control function according to the touch occurrence positions of the three points, the touch movement direction, and the movement distance.

In an embodiment, when touch occurrence positions of three points are detected in the central divided area and the touch occurrence positions of the three points move in any one of Y-axis and −Y-axis directions and X-axis and −X-axis directions according to the comparison result between the arrangement coordinates of the touch nodes and the touch coordinates which are input in real time, the display driving circuit may generate digital video data so as to include a menu bar display a preset operation control function based on a three-point touch of the central divided area and displays the digital video data as an image, and execute the preset operation control function based on the three-point touch of the central divided area according to the touch occurrence positions of the three points, the touch movement direction, and the movement distance.

In an embodiment of the disclosure, a portable display device includes a display panel displaying an image with pixels of a display area, a touch sensor disposed in a front surface direction of the display area and a non-display area of the display panel so as to correspond to the display area and a preset partial area of the non-display area, a touch driving circuit driving touch electrodes of the touch sensor to detect a touch occurrence position of at least one point, a touch movement direction, and a movement distance and generating touch coordinate data according to a detection result, and a display driving circuit dividing a touch sensing area of the touch sensor into a plurality of peripheral areas, a plurality of divided areas, and a central divided area based on arrangement coordinates of touch nodes arranged in the touch sensing area, deciding a touch occurrence position of at least one point, a touch movement direction, and a movement distance for each of the plurality of peripheral areas, the plurality of divided areas, and the central divided area, and controlling an image display screen of the display panel according to a decision result.

In an embodiment, the display driving circuit compares touch coordinates of the touch coordinate data with the arrangement coordinates of the touch nodes and divides the touch occurrence position of the at least one point, the touch movement direction, and the movement distance for each of the plurality of peripheral areas, the plurality of divided areas, and the central divided area.

In an embodiment, the display driving circuit generates digital video data including an icon or a menu bar so that a user confirms and controls at least one screen control function of brightness, chromaticity, resolution, and contrast control functions so as to correspond to the touch occurrence position of the at least one point, the touch movement direction, and the movement distance divided for each of the plurality of peripheral areas, the plurality of divided areas, and the central divided area, generates digital video data including the icon or the menu bar so that the user confirms and controls at least one operation control function of volume, power, and mute control functions so as to correspond to the touch occurrence position of the at least one point, the touch movement direction, and the movement distance, and controls the screen control function or the operation control function according to the touch occurrence position of the at least one point, the touch movement direction, and the movement distance changed in real time.

In an embodiment, the display driving circuit divides first to fourth peripheral areas by dividing arrangement coordinates of the touch nodes each disposed in outer areas having a preset size in one direction, a lower direction, another direction, and an upper direction of the touch sensing area, divides first to fourth divided areas in first to fourth corner directions according to arrangement positions of corner arrangement coordinates in four directions that do not overlap the first to fourth peripheral areas, and divides a central area of the touch sensing area into the central divided area which does not overlap the first to fourth divided areas, and the first to fourth peripheral areas are divided in a preset bezel area or an area corresponding to or overlapping the non-display area.

In an embodiment, when a touch occurrence position of one point is detected in any one of the first to fourth peripheral areas and the touch occurrence position of the one point moves in preset Y-axis and −Y-axis directions or preset X-axis and −X-axis directions according to a comparison result between the arrangement coordinates of the touch nodes and the touch coordinates which are input in real time, the display driving circuit may generate digital video data so as to include an icon displaying any one screen control function selected among first to fourth screen control functions preset for each of the first to fourth peripheral areas and displays the digital video data as an image, and execute the selected one screen control function according to the touch occurrence position of the one point, the touch movement direction, and the movement distance.

In an embodiment, when touch occurrence positions of two points are detected in any one of the first to fourth divided areas and the touch occurrence positions of the two points move in any one of Y-axis and −Y-axis directions and X-axis and −X-axis directions according to a comparison result between the arrangement coordinates of the touch nodes and the touch coordinates which are input in real time, the display driving circuit may generate digital video data so as to include a menu bar displaying any one operation control function selected among first to fourth operation control functions preset for each of the first to fourth divided areas and displays the digital video data as an image, and execute the selected one operation control function according to the touch occurrence positions of the two points, the touch movement direction, and the movement distance.

In an embodiment, when touch occurrence positions of two points are detected in the central divided area and the touch occurrence positions of the two points move in any one of Y-axis and −Y-axis directions and X-axis and −X-axis directions according to a comparison result between the arrangement coordinates of the touch nodes and the touch coordinates which are input in real time, the display driving circuit may generate digital video data so as to include a menu bar display a preset operation control function based on a two-point touch of the central divided area and displays the digital video data as an image, and execute the preset operation control function based on the two-point touch of the central divided area according to the touch occurrence positions of the two points, the touch movement direction, and the movement distance.

In an embodiment, when touch occurrence positions of three points are detected in any one of the first to fourth divided areas and the touch occurrence positions of the three points move in any one of Y-axis and −Y-axis directions and X-axis and −X-axis directions according to a comparison result between the arrangement coordinates of the touch nodes and the touch coordinates which are input in real time, the display driving circuit may generate digital video data as an image so as to include a menu bar displaying any one operation control function selected among fifth to eighth operation control functions preset for each of the first to fourth divided areas and displays the digital video data as an image, and execute the selected one operation control function according to the touch occurrence positions of the three points, the touch movement direction, and the movement distance.

In an embodiment, when touch occurrence positions of three points are detected in the central divided area and the touch occurrence positions of the three points move in any one of Y-axis and −Y-axis directions and X-axis and −X-axis directions according to a comparison result between the arrangement coordinates of the touch nodes and the touch coordinates which are input in real time, the display driving circuit may generate digital video data so as to include a menu bar display a preset operation control function based on a three-point touch of the central divided area and displays the digital video data as an image, and execute the preset operation control function based on the three-point touch of the central divided area according to the touch occurrence positions of the three points, the touch movement direction, and the movement distance.

With a portable display device in an embodiment, it is possible to improve an interface function and convenience of users by displaying icons, menu bars, or the like, capable of selecting or controlling built-in functions according to a user's screen touch position and touch operation.

In addition, with a portable display device in an embodiment, it is possible to improve satisfaction and reliability of users by supporting the users so as to be capable of controlling predetermined built-in functions with only a one-touch movement operation according to a user's touch position.

The effects of the disclosure are not limited to the aforementioned effects, and various other effects are included in the specification.

### BRIEF DESCRIPTION OF THE DRAWINGS

The above and other embodiments and features of the disclosure will become more apparent by describing in detail embodiments thereof with reference to the attached drawings, in which:

FIG. 1 is a plan view illustrating an embodiment of a configuration of a portable display device according to the disclosure;

FIG. 2 is a side cross-sectional view illustrating the portable display device illustrated in FIG. 1 in detail:

FIG. 3 is a schematic layout diagram illustrating an embodiment of a display panel:

FIG. 4 is a schematic layout diagram illustrating an embodiment of a touch sensor:

FIG. 5 is a block diagram illustrating peripheral areas, divided areas, and a central divided area divided in a touch sensing area of FIG. 4:

FIG. 6 is a block diagram illustrating a method of sensing one-touch movement in the peripheral areas illustrated in FIGS. 4 and 5:

FIG. 7 is a schematic view of a first embodiment illustrating an icon display screen according to one-touch movement sensing in any one peripheral area illustrated in FIG. 6:

FIG. 8 is a schematic view of a second embodiment illustrating an icon display screen according to one-touch movement sensing in any one peripheral area illustrated in FIG. 6:

FIG. 9 is a block diagram illustrating a method of sensing one-touch movement in the divided areas and the central divided area illustrated in FIGS. 4 and 5:

FIG. 10 is an enlarged block diagram illustrating a method of sensing one-touch movement in a second divided area illustrated in FIG. 9;

FIG. 11 is a schematic view of a third embodiment illustrating a menu bar display screen according to one-touch movement sensing in the second divided area illustrated in FIG. 10:

FIG. 12 is a block diagram of another embodiment illustrating a method of sensing one-touch movement in the divided areas and the central divided area illustrated in FIGS. 4 and 5:

FIG. 13 is an enlarged block diagram illustrating a method of sensing one-touch movement in the central divided area illustrated in FIG. 12;

FIG. 14 is a schematic view of a fourth embodiment illustrating an icon display screen according to one-touch movement sensing in the second divided area illustrated in FIG. 13:

FIG. 15 is a schematic view of a fifth embodiment illustrating an icon display screen according to one-touch movement sensing in the central divided area illustrated in FIG. 13:

FIG. 16 is an illustrative view illustrating an embodiment of an instrument board and a center fascia of a vehicle including the portable display device according to the disclosure:

FIG. 17 is an illustrative view illustrating an embodiment of a watch-type smart device including the portable display device according to the disclosure:

FIG. 18 is an illustrative view illustrating an embodiment of a transparent display device including the portable display device according to the disclosure; and

FIG. 19 is a perspective view illustrating an embodiment of a foldable smart device including the portable display device according to the disclosure.

### DETAILED DESCRIPTION

The disclosure will now be described more fully hereinafter with reference to the accompanying drawings, in which preferred embodiments of the disclosure are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the disclosure. Similarly, the second element could also be termed the first element.

The term “part” or “unit” as used herein is intended to mean a software component or a hardware component that performs a predetermined function. The hardware component may include a field-programmable gate array (“FPGA”) or an application-specific integrated circuit (“ASIC”), for example. The software component may refer to an executable code and/or data used by the executable code in an addressable storage medium. Thus, the software components may be object-oriented software components, class components, and task components, and may include processes, functions, attributes, procedures, subroutines, segments of program code, drivers, firmware, micro codes, circuits, data, a database, data structures, tables, arrays, or variables, for example.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Each of the features of the various embodiments of the disclosure may be combined or combined with each other, in part or in whole, and technically various interlocking and driving are possible. Each embodiment may be implemented independently of each other or may be implemented together in an association.

Hereinafter, illustrative embodiments will be described with reference to the accompanying drawings.

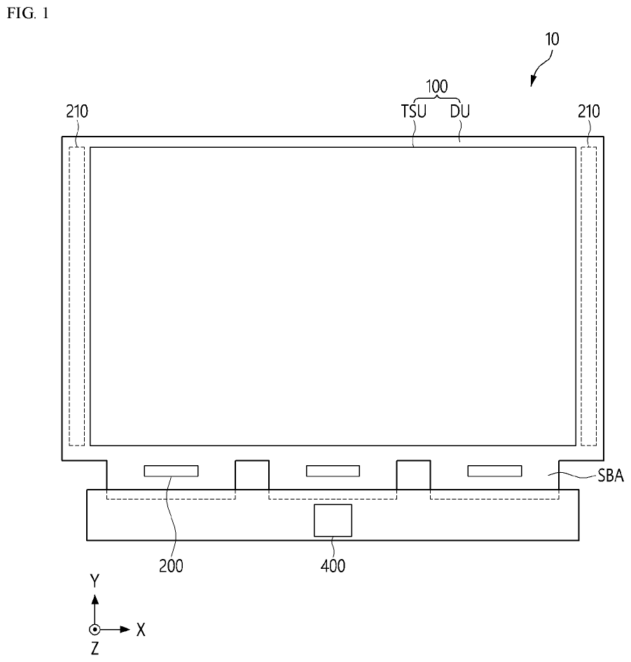

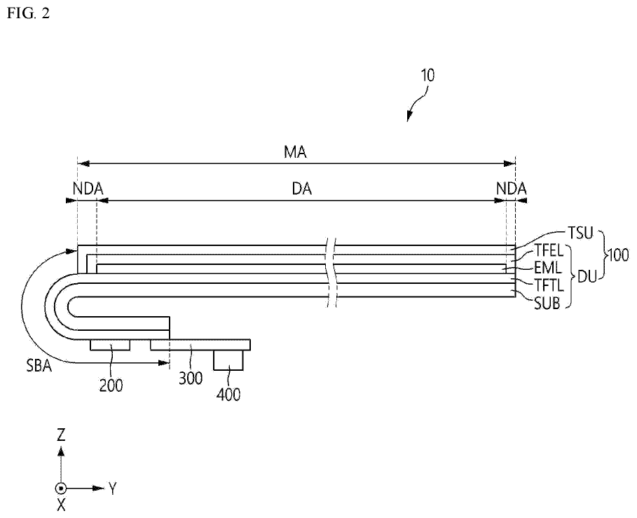

FIG. 1 is a plan view illustrating an embodiment of a configuration of a portable display device according to the disclosure. In addition, FIG. 2 is a side cross-sectional view illustrating the portable display device illustrated in FIG. 1 in detail.

Referring to FIGS. 1 and 2, a portable display device 10 in an embodiment may be variously classified according to a display method. In an embodiment, the portable display device may be classified and configured into an organic light-emitting display (“OLED”), an inorganic light-emitting display (“inorganic EL”), a quantum dot light-emitting display (“QED”), a micro light-emitting diode (“LED”) display (“micro-LED”), a nano LED display (“nano-LED”), a plasma display panel (“PDP”), a field emission display (“FED”), a liquid crystal display (“LCD”), an electrophoretic display (“EPD”), or the like. Hereinafter, an OLED will be described as an embodiment of the portable display device 10, and a portable OLED applied to an embodiment will be abbreviated as a display device 10 unless special distinction is desired, for example. The display device 10 in an embodiment is not limited to the OLED, and may be other display devices mentioned above or known in the art without departing from the technical idea.

the display device 10 in an embodiment may be applied to an instrument board of a vehicle, a center fascia of the vehicle, or a center information display (“CID”) disposed on a dashboard of the vehicle or may be applied to a room mirror display device substituting for side-view mirrors of the vehicle. The display device 10 used in the vehicle may include a relatively large screen display panel 100 that displays instrument information of the instrument board, operation information of electric devices, a navigation image, a camera image, sensing information, or the like, on one screen.

The display device 10 in an embodiment may be applied to portable electronic devices such as mobile phones, smartphones, tablet personal computers (“PCs”), mobile communication terminals, electronic notebooks, electronic books, portable multimedia players (“PMPs”), navigation devices, and ultra mobile PCs (“UMPCs”). In an embodiment, the display device 10 may be applied as a display unit of televisions, laptop computers, monitors, billboards, or the Internet of Things (“IOTs”). In another embodiment, the display device 10 may be applied to wearable devices such as smart watches, watch phones, glasses-type displays, and head mounted displays (“HMDs”).

The display device 10 in an embodiment may be formed in at least one of a quadrangular shape, e.g., rectangular shape, a square shape, a circular shape, and an elliptical shape in a plan view. In an embodiment, when the display device 10 is used in the vehicle, the display device 10 may be formed in a rectangular shape of which short sides are disposed in a longitudinal direction and long sides are disposed in a transverse direction. A structure of the display device 10 in a plan view is not limited thereto, and the display device 10 may be formed in a rectangular shape of which long sides are disposed in a longitudinal direction or may be rotatably installed, such that long sides may be variably disposed in a transverse direction or a longitudinal direction.

As illustrated in FIGS. 1 and 2, the display device 10 includes a touch sensing module, and the touch sensing module includes a touch sensor TSU disposed on a front surface of a display panel 100 and at least one touch driving circuit 200 generating touch coordinate data of the touch sensor TSU.

Specifically, the display panel 100 of the display device 10 includes a display unit DU displaying an image, and the touch sensor TSU sensing a touch by a body part such as a finger and a touch input device such as an electronic pen is disposed on the display unit DU of the display panel 100.

The display unit DU of the display panel 100 may include a plurality of pixels and display the image through the plurality of pixels. Here, each pixel may include red, green, and blue sub-pixels or may include red, green, blue, and white sub-pixels.

The touch sensor TSU may be disposed (e.g., mounted) in a front surface direction of the display panel 100 or formed integrally with the display panel 100 on a front surface portion of the display panel 100. The touch sensor TSU may include a plurality of touch electrodes and sense a user's touch in a capacitive manner using the touch electrodes. The touch sensor TSU may be disposed (e.g., mounted) on the display unit DU of the display panel 100 or formed integrally with the display unit DU.

The touch driving circuit 200 may be formed as at least one microprocessor type electrically connected to the touch sensor TSU, that is, each touch sensing area. The touch driving circuit 200 may supply touch driving signals to the touch electrodes arranged in a matrix structure in the touch sensor TSU, and may sense change amounts in capacitance between the touch electrodes. The touch driving circuit 200 may confirm a user's touch input based on the change amounts in capacitance between the touch electrodes and calculate touch coordinate data. Detailed components and structural characteristics of the touch driving circuit 200 and the touch sensor TSU will be described in more detail later with reference to the accompanying drawings.

A display driving circuit 400 may output control signals and data voltages for driving the pixels of the display unit DU, e.g., sub-pixels each divided into red, green, blue, and white sub-pixels. The display driving circuit 400 may supply the data voltages to data lines to which the sub-pixels are connected. The display driving circuit 400 may supply source voltage to power lines and may supply gate control signals to at least one gate driver 210. In the display driving circuit 400, a timing controller performing a timing control function and a data driver supplying the data voltages to the data lines may be separately distinguished from each other. In this case, the display driving circuit 400 may control driving timings of the gate driver 210 and the data driver by supplying a timing control signal to at least one gate driver 210 and the data driver.

The display driving circuit 400 may control overall functions of the display device 10. In an embodiment, the display driving circuit 400 may receive touch coordinate data for the touch sensor TSU from the touch driving circuit 200, decide user's touch coordinates, and generate digital video data according to the touch coordinates. In addition, the display driving circuit 400 may execute an application indicated by an icon displayed at the user's touch coordinates. In another embodiment, the display driving circuit 400 may receive coordinate data from an electronic pen or the like, decide touch coordinates of the electronic pen, and then generate digital video data according to the touch coordinates or execute an application indicated by an icon displayed at the touch coordinates of the electronic pen.

Referring to FIG. 2, the display panel 100 may be divided into a main area MA and a sub-area SBA. The main area MA may include a display area DA including sub-pixels displaying an image and a non-display area NDA disposed around the display area DA. In the display area DA, an image may be displayed by emitting light from emission areas or opening areas of the respective sub-pixels. To this end, the sub-pixels arranged in the display area DA may include pixel circuits including switching elements, a pixel defining layer defining the emission areas or the opening areas, and self-light-emitting elements.

The non-display area NDA may be a peripheral area of the display area DA, that is, an area outside the display area DA. The non-display area NDA may be defined as an edge area of the main area MA corresponding to the display area DA of the display panel 100. The non-display area NDA may include at least one gate driver 210 supplying gate signals to gate lines and fan-out lines (not illustrated) connecting the display driving circuit 400 and the display area DA to each other.

The sub-area SBA may extend from one side of the main area MA. The sub-area SBA may include a flexible material that may be bent, folded, and rolled. In an embodiment, when the sub-area SBA is bent, the sub-area SBA may overlap the main area MA in a thickness direction (Z-axis direction), for example. The sub-area SBA may include the display driving circuit 400 and pad parts connected to a circuit board 300. In an alternative embodiment, the sub-area SBA may be omitted, and the display driving circuit 400 and the pad parts may be disposed in the non-display area NDA.

The circuit board 300 may be attached onto the pad parts of the display panel 100 using an anisotropic conductive film (“ACF”). Lead lines of the circuit board 300 may be electrically connected to the pad parts of the display panel 100. The circuit board 300 may be a flexible printed circuit board, a printed circuit board, or a flexible film such as a chip on film.

A substrate SUB of the display panel 100 illustrated in FIG. 2 may be a base substrate or a base member. The substrate SUB may be a flat-type substrate. In an alternative embodiment, the substrate SUB may be a flexible substrate that may be bent, folded, and rolled. In an embodiment, the substrate SUB may include a glass material or a metal material, but is not limited thereto. In another embodiment, the substrate SUB may include a polymer resin such as polyimide (“PI”).

A thin film transistor layer TFTL may be disposed on the substrate SUB. The thin film transistor layer TFTL may include a plurality of thin film transistors constituting a pixel circuit of each of the sub-pixels. The thin film transistor layer TFTL may further include gate lines, data lines, power lines, gate control lines, fan-out lines connecting the display driving circuit 400 and the data lines to each other, and lead lines connecting the display driving circuit 400 and the pad parts to each other. When the gate drivers 210 are formed on one side and an opposite side of the non-display area NDA of the display panel 100, respectively, the respective gate drivers may also include thin film transistors.

The thin film transistor layer TFTL may be selectively disposed in the display area DA, the non-display area NDA, and the sub-area SBA. The thin film transistors of each of the pixels, the gate lines, the data lines, and the power lines of the thin film transistor layer TFTL may be disposed in the display area DA. The gate control lines and the fan-out lines of the thin film transistor layer TFTL may be disposed in the non-display area NDA. The lead lines of the thin film transistor layer TFTL may be disposed in the sub-area SBA.

A light-emitting element layer EML may be disposed on the thin film transistor layer TFTL. The light-emitting element layer EML may include a plurality of light-emitting elements in which a first electrode, a light-emitting layer, and a second electrode are sequentially stacked to emit light and a pixel defining layer defining the respective sub-pixels. The light-emitting elements of the light-emitting element layer EML may be disposed in the display area DA.

An encapsulation layer TFEL may cover an upper surface and side surfaces of the light-emitting element layer EML, and may protect the light-emitting element layer EML. The encapsulation layer TFEL may include at least one inorganic layer and at least one organic layer for encapsulating the light-emitting element layer EML.

The touch sensor TSU including a touch sensing area may be disposed on the encapsulation layer TFEL of the display panel 100. The touch sensing area of the touch sensor TSU may include a plurality of touch electrodes for sensing a user's touch in a capacitive manner and touch driving lines connecting the plurality of touch electrodes and at least one touch driving circuit 200 to each other. In each touch sensing area, the touch electrodes may be arranged in a matrix structure to sense the user's touch using a self-capacitance manner or a mutual capacitance manner.

The touch sensor TSU may not be formed integrally with the display panel 100, and may be disposed on a separate substrate or film disposed on the display unit DU of the display panel 100. In this case, the substrate or the film supporting the touch sensor TSU may be a base member encapsulating the display unit DU. Hereinafter, an embodiment in which the touch sensor TSU is formed integrally with the display panel 100 on a front surface of the display panel 100 will be described.

The plurality of touch electrodes may be disposed in the touch sensing area overlapping the display area DA. Touch lines transmitting touch driving signals or touch sensing signals may be disposed in a touch peripheral area overlapping the non-display area NDA.

The touch driving circuit 200 generating the touch coordinate data for the touch sensing area may be disposed in the non-display area NDA or sub-area SBA of the display panel 100. In an alternative embodiment, the touch driving circuit 200 generating the touch coordinate data may be disposed (e.g., mounted) on a separate circuit board 300. Such a touch driving circuit 200 may be formed as an integrated circuit (“IC”).

The touch driving circuit 200 supply the touch driving signals to the touch electrodes of the touch sensing area overlapping the display area DA, and measures a charge change amount of mutual capacitance of each of a plurality of touch nodes formed by the touch electrodes. In this case, the touch driving circuit 200 measures changes in capacitance of the touch nodes according to changes in voltage magnitude or current amount of touch sensing signals received through the touch electrodes. As such, the touch driving circuit 200 may decide a user's touch position according to the charge change amount of the mutual capacitance of each of the touch nodes. Here, the touch driving signal may be a pulse signal having a predetermined frequency. The touch driving circuit 200 calculates a touch input and touch coordinates by a touch input device or a user's body part such as a finger, for each touch sensing area based on a change amount in capacitance between the touch electrodes for each touch sensing area.

The touch driving circuit 200 may pre-divide the touch sensing area overlapping the display area DA into a plurality of peripheral areas, a plurality of divided areas, and a central divided area, and output touch coordinate data for each of the plurality of peripheral areas, the plurality of divided areas, and the central divided area. In an embodiment, the touch driving circuit 200 may pre-divide and divide the touch sensing area into a plurality of peripheral areas, a plurality of divided areas, and a central divided area using arrangement coordinates of the touch nodes formed and arranged in a matrix form in the touch sensing area, for example. In addition, when the touch driving circuit 200 generates the touch coordinate data according to touch occurrence and touch sensing, the touch driving circuit 200 may compare touch coordinates of the touch coordinate data with the arrangement coordinates of the touch nodes to divide a touch occurrence position for each of the plurality of peripheral areas, the plurality of divided areas, and the central divided area. The touch driving circuit 200 may transmit the touch coordinate data to the display driving circuit 400 together with an area code divided for each of the plurality of peripheral areas, the plurality of divided areas, and the central divided area.

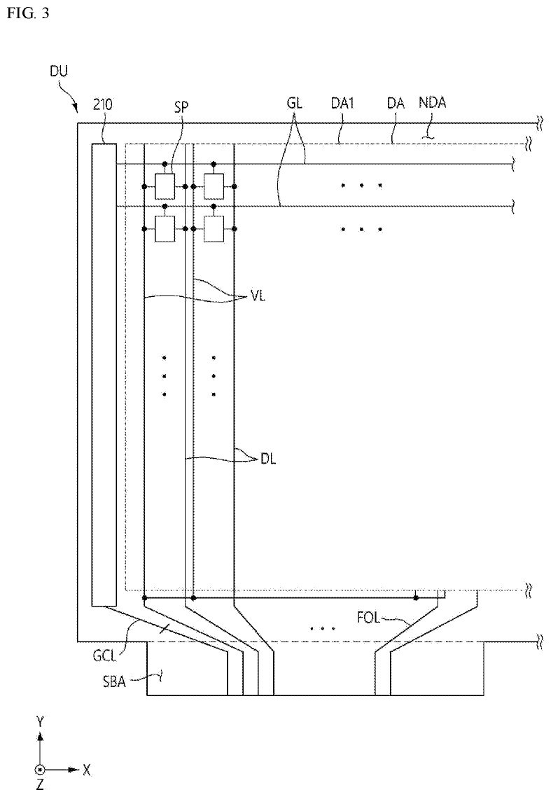

FIG. 3 is a schematic layout diagram illustrating an embodiment of a display panel. Specifically, FIG. 3 is a layout diagram partially illustrating a display area DA and a non-display area NDA of the display unit DU in a state before the touch sensor TSU is formed.

The display area DA is an area displaying an image, and may be defined as a central area of the display panel 100. In an embodiment, the display area DA may include a plurality of sub-pixels SP, a plurality of gate lines GL, a plurality of data lines DL, a plurality of power lines VL, or the like. Each of the plurality of sub-pixels SP may be defined as a minimum unit outputting light such as red light, green light, blue light, or white light.

The plurality of gate lines GL may supply the gate signals received from at least one gate driver 210 to the plurality of sub-pixel SP. The plurality of gate lines GL may extend in an X-axis direction and may be spaced apart from each other in a Y-axis direction crossing the X-axis direction.

The plurality of data lines DL may supply the data voltages received from the display driving circuit 400 to the plurality of sub-pixels SP. The plurality of data lines DL may extend in the Y-axis direction and may be spaced apart from each other in the X-axis direction.

The plurality of power lines VL may supply a source voltage applied from the display driving circuit 400 or a separate power supply unit to the plurality of sub-pixels SP. Here, the source voltage may be at least one of a driving voltage, an initialization voltage, and a reference voltage. The plurality of power lines VL may extend in the Y-axis direction and may be spaced apart from each other in the X-axis direction.

The non-display area NDA is a peripheral area of the display area DA and surrounds the display area DA where an image is displayed, and may finally be defined as a bezel area. The non-display area NDA may include the gate driver 210, fan-out lines FOL, and gate control lines GCL. The gate driver 210 may generate a plurality of gate signals based on gate control signals, and may sequentially supply the plurality of gate signals to the plurality of gate lines GL according to a set order.

The fan-out lines FOL may extend from the display driving circuit 400 to each display area DA. The fan-out lines FOL may supply the data voltages received from the display driving circuit 400 to the plurality of data lines DL.

The gate control lines GCL may extend from the display driving circuit 400 to the gate driver 210. The gate control lines GCL may supply the gate control signals received from the display driving circuit 400 to the gate driver 210.

The display driving circuit 400 may output signals and voltages for driving the display panel 100 to the fan-out lines FOL. The display driving circuit 400 may supply the data voltages to the data lines DL through the fan-out lines FOL. The data voltages may be supplied to the plurality of sub-pixels SP, and may determine luminance of the plurality of sub-pixels SP. The display driving circuit 400 may supply the gate control signals to the gate driver 210 through the gate control lines GCL.

As described above, the display driving circuit 400 may control overall functions of the display device 10. In particular, the display driving circuit 400 pre-divides and divides the touch sensing area formed to overlap the display area DA and some areas of the non-display area NDA into a plurality of peripheral areas, a plurality of divided areas, and a central divided area. In this case, the display driving circuit 400 may pre-divide and divide the touch sensing area into the plurality of peripheral areas, the plurality of divided areas, and the central divided area using arrangement coordinates of the touch nodes arranged in a matrix form in the touch sensing area. In this case, the display driving circuit 400 divides the touch sensing area overlapping and corresponding to the display area DA into the plurality of divided areas and the central divided area. In addition, the display driving circuit 400 may divide the touch sensing area formed to overlap and correspond to some areas of the non-display area NDA into the plurality of peripheral areas. Accordingly, areas divided as the plurality of peripheral areas may correspond to the bezel area of the display panel 100.

The display driving circuit 400 may compare touch coordinates of touch coordinate data which is input from the touch driving circuit 200 when a touch occurs with the arrangement coordinates of the touch nodes, and divide a touch occurrence position, a touch movement direction, or the like, for each of the plurality of peripheral areas, the plurality of divided areas, and the central divided area according to a comparison result.

In addition, the display driving circuit 400 may generate digital video data for controlling built-in functions preset to each correspond to the touch position and the touch movement direction divided for each of the plurality of peripheral areas, the plurality of divided areas, and the central divided area. In an embodiment, the display driving circuit 400 may generate digital video data such as an icon or a menu bar so that a user may confirm and control a screen control function such as brightness, chromaticity, resolution, and contrast, an operation control function such as volume, power, and mute, or the like, for example, according to the touch position and the touch movement direction for each of the peripheral areas or the divided areas. In addition, the display driving circuit 400 may control built-in functions such as the screen control function or the operation control function according to a user's touch operation decided and recognized in real time through the touch coordinate data and execute an application program.

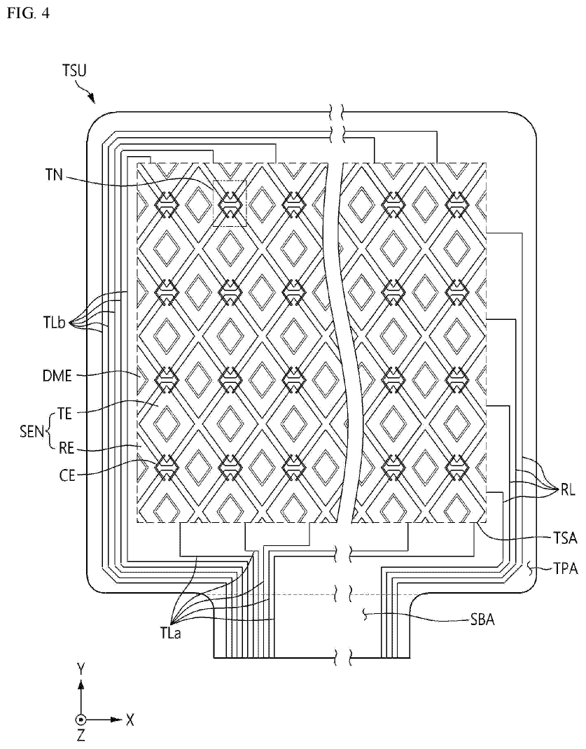

FIG. 4 is a schematic layout diagram illustrating an embodiment of a touch sensor. Specifically, FIG. 4 is a layout diagram illustrating a planar structure of the touch sensing area TSA corresponding to the display area DA.

Referring to FIG. 4, the touch sensor TSU may include a touch sensing area TSA sensing a user's touch and a touch peripheral area TPA defined as a peripheral area of the touch sensing area TSA.

The touch sensing area TSA may cover the display area DA and the non-display area NDA of the display unit DU to overlap the display area DA and the non-display area NDA. Since the non-display area NDA is the bezel area, outer areas of the touch sensing area TSA overlapping and corresponding to the non-display area NDA correspond to the bezel area.

The touch peripheral area TPA corresponds to an area in which the gate driver 210 is disposed. Accordingly, the touch sensing area TSA extends, overlaps, and is disposed on the non-display area NDA except for the area where the gate driver 210 is disposed.

The touch sensing area TSA may include a plurality of touch electrodes SEN and a plurality of dummy electrodes DME. The plurality of touch electrodes SEN may form mutual capacitance or self-capacitance in order to sense a touch of an object or a person. The plurality of touch electrodes SEN may include a plurality of driving electrodes TE and a plurality of sensing electrodes RE.

The plurality of driving electrodes TE may be arranged in the X-axis direction and the Y-axis direction. The plurality of driving electrodes TE may be spaced apart from each other in the X-axis direction and the Y-axis direction. The driving electrodes TE adjacent to each other in the Y-axis direction may be electrically connected to each other through a plurality of connection electrodes CE.

The plurality of driving electrodes TE may be connected to first touch pads through driving lines TL. The driving lines TL may include lower driving lines TLa and upper driving lines TLb. In an embodiment, some driving electrodes TE disposed on the lower side of the touch sensing area TSA may be connected to the first touch pads through the lower driving lines TLa, and some other driving electrodes TE disposed on the upper side of the touch sensing area TSA may be connected to the first touch pads through the upper driving lines TLb, for example. The lower driving lines TLa may pass through the lower side of the touch peripheral area TPA and extend to the first touch pads. The upper driving lines TLb may extend to the first touch pads via the upper side, the left side, and the lower side of the touch peripheral area TPA. Here, the touch pads (not illustrated) may be pads formed on the circuit board 300 or the like and connected to at least one touch driving circuit 200.

The driving electrodes TE adjacent to each other in the Y-axis direction may be electrically connected to each other by the plurality of connection electrodes CE, and even though any one of the plurality of connection electrodes CE is disconnected, the driving electrodes TE may be stably connected to each other through other connection electrodes CE. The driving electrodes TE adjacent to each other may be connected to each other by two connection electrodes CE, but the number of connection electrodes CE is not limited thereto.

The connection electrode CE may be bent at least once. In an embodiment, the connection electrode CE may have a clamp shape (“<” or “>”), for example, but a shape of the connection electrode CE in a plan view is not limited thereto.

The connection electrodes CE may be disposed at a different layer from the plurality of driving electrodes TE and the plurality of sensing electrodes RE. The driving electrodes TE adjacent to each other in the Y-axis direction may be electrically connected to each other through the connection electrodes CE disposed at the different layer from the plurality of driving electrodes TE and the plurality of sensing electrodes RE. The connection electrodes CE may be formed at a rear surface layer (or a lower layer) of a layer at which the driving electrodes TE and the sensing electrodes RE are formed. The connection electrodes CE are electrically connected to the respective adjacent driving electrodes TE through a plurality of contact holes. Accordingly, even though the connection electrodes CE overlap the plurality of sensing electrodes RE in the Z-axis direction, the plurality of driving electrodes TE and the plurality of sensing electrodes RE may be insulated from each other. Mutual capacitance may be formed between the driving electrodes TE and the sensing electrodes RE.

The sensing electrodes RE adjacent to each other in the X-axis direction may be electrically connected to each other through connection parts disposed at the same layer as the plurality of driving electrodes TE or the plurality of sensing electrodes RE. That is, the plurality of sensing electrodes RE may extend in the X-axis direction and may be spaced apart from each other in the Y-axis direction. The plurality of sensing electrodes RE may be arranged in the X-axis direction and the Y-axis direction, and the sensing electrodes RE adjacent to each other in the X-axis direction may be electrically connected to each other through the connection parts.

Touch nodes TN may be formed in areas in which the connection electrodes CE connecting the driving electrodes TE to each other and the connection parts of the sensing electrodes RE intersect with each other, and may be arranged in a matrix form in the touch sensing area TSA.

The plurality of sensing electrodes RE may be connected to second touch pads through sensing lines RL. In an embodiment, some sensing electrodes RE disposed on the right side of the touch sensing area TSA may be connected to the second touch pads through the sensing lines RL, for example. The sensing lines RL may extend to the second touch pads via the right side and the lower side of the touch peripheral area TPA. The second touch pads may be connected to at least one touch driving circuit 200 through the circuit board 300.

Each of the plurality of dummy electrodes DME may be surrounded by the driving electrode TE or the sensing electrode RE. Each of the plurality of dummy electrodes DME may be spaced apart and insulated from the driving electrode TE or the sensing electrode RE. Accordingly, the dummy electrodes DME may be electrically floated.

The touch driving circuit 200 supplies the touch driving signals to the plurality of driving electrodes TE. In addition, the touch driving circuit 200 receives signals fed back from each of the plurality of driving electrodes TE as touch sensing signals of the driving electrodes TE, and receives touch sensing signals for the sensing electrodes RE from each of the plurality of sensing electrodes RE. Accordingly, the touch driving circuit 200 measures a charge change amount of mutual capacitance of each of the touch nodes TN formed by the plurality of driving electrodes TE and the plurality of sensing electrodes RE by measuring changes in magnitude of the touch sensing signals received from the plurality of driving electrodes TE and the plurality of sensing electrodes RE. The touch driving circuit 200 may decide a user's touch position and touch movement direction according to the charge change amount of the mutual capacitance of each of the touch nodes. As such, the touch driving circuit 200 calculates the touch input and the touch coordinates by the touch input device or the user's body part such as the finger, for each touch sensing area based on a change amount in capacitance between the touch electrodes.

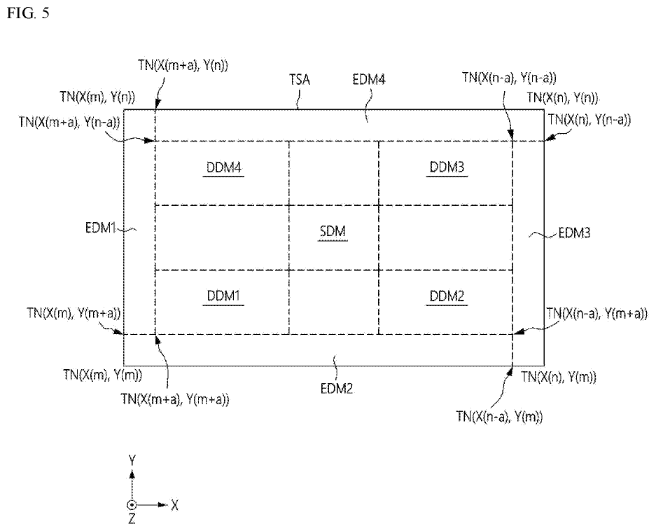

FIG. 5 is a block diagram illustrating peripheral areas, divided areas, and a central divided area divided in a touch sensing area of FIG. 4.

Referring to FIG. 5, the touch driving circuit 200 or the display driving circuit 400 may divide the touch sensing area TSA into a plurality of peripheral areas EDM1 to EDM4, a plurality of divided areas DDM1 to DDM4, and a central divided area SDM using the arrangement coordinates of the touch nodes TN arranged in the touch sensing area TSA. Hereinafter, an embodiment in which the display driving circuit 400 pre-divides and divides the touch sensing area TSA into the plurality of peripheral areas EDM1 to EDM4, the plurality of divided areas DDM1 to DDM4, and the central divided area SDM will be described.

As described above, the touch nodes TN may be formed in intersection areas in which the drive electrodes TE and the sensing electrodes RE of the touch sensing area TSA intersect with each other, and may be arranged in the matrix form in the touch sensing area TSA.

As illustrated in FIG. 5, the display driving circuit 400 may divide the touch sensing area TSA into the plurality of peripheral areas EDM1 to EDM4, the plurality of divided areas DDM1 to DDM4, and the central divided area SDM using the arrangement coordinates of the touch nodes TN arranged in the touch sensing area TSA. Here, the plurality of divided areas DDM1 to DDM4 and the central divided area SDM may be divided and defined as areas corresponding to the display area DA of the display unit DU. The plurality of peripheral areas EDM1 to EDM4 may be divided and defined as areas corresponding to the non-display area NDA of the display unit DU. Accordingly, the plurality of peripheral areas EDM1 to EDM4 may correspond to the bezel area, which is the non-display area NDA.

In an embodiment, the display driving circuit 400 may divide an area included in an arrangement range of a touch node (TN(X(m+a), Y(n))) of a coordinate point (X(m+a), Y(n)), a touch node (TN(X(m+a), Y(m+a))) of a coordinate point (X(m+a), Y(m+a)), and a touch node (TN(X(m), Y(m+a))) of a coordinate point (X(m), Y(m+a)) based on a touch node (TN(X(m), Y(n))) of a coordinate point (X(m), Y(n)) along an outer edge of the touch sensing area TSA in one direction as a first peripheral area EDM1. Here, m is 0 or a positive integer greater than 0, and a is a positive integer greater than m. In addition, n is a positive integer greater than a.

The display driving circuit 400 may divide an area included in an arrangement range of the touch node (TN(X(m), Y(m+a))) of the coordinate point (X(m), Y(m+a)), a touch node (TN(X(n−a), Y(m+a))) of a coordinate point (X(n−a), Y(m+a)), and a touch node (TN(X(n−a), Y(m))) of a coordinate point (X(n−a), Y(m)) based on a touch node (TN(X(m), Y(m))) of a coordinate point (X(m), Y(m)) along an outer edge of the touch sensing area TSA in a lower direction as a second peripheral area EDM2.

In addition, the display driving circuit 400 may divide an area included in an arrangement range of the touch node (TN(X(n−a), Y(m))) of the coordinate point (X(n−a), Y(m)), a touch node (TN(X(n−a), Y(n−a))) of a coordinate point (X(n−a), Y(n−a)), and a touch node (TN(X(n), Y(n−a))) of a coordinate point (X(n), Y(n−a)) based on a touch node (TN(X(n), Y(m))) of a coordinate point (X(n), Y(m)) along an outer edge of the touch sensing area TSA in another direction as a third peripheral area EDM3.

In addition, the display driving circuit 400 may divide an area included in an arrangement range of the touch node (TN(X(n), Y(n−a))) of the coordinate point (X(n), Y(n−a)), a touch node (TN(X(m+a), Y(n−a))) of a coordinate point (X(m+a), Y(n−a)), and the touch node (TN(X(m+a), Y(n))) of the coordinate point (X(m+a), Y(n)) based on a touch node (TN(X(n), Y(n))) of a coordinate point (X(n), Y(n)) along an outer edge of the touch sensing area TSA in an upper direction as a fourth peripheral area EDM4. As described above, the first to fourth peripheral areas EDM1 to EDM4 may be peripheral areas adjacent to outer components such as a bezel or bezel areas.

The display driving circuit 400 divides an inner central area of the touch sensing area TSA into the plurality of divided areas DDM1 to DDM4 and the central divided area SDM so as not to overlap the first to fourth peripheral areas EDM1 to EDM4 divided in the touch sensing area TSA. In an embodiment, the display driving circuit 400 may divide first to fourth divided areas DDM1 to DDM4 in first to fourth corner directions according to arrangement positions of respective corner coordinates that do not overlap the first to fourth peripheral areas EDM1 to EDM4, for example. Here, the display driving circuit 400 may divide a first divided area DDM1 having a preset size in an arrangement direction of the touch node (TN(X(m+a), Y(m+a))) of the coordinate point (X(m+a), Y(m+a)), which is a preset first corner coordinate point, and divide a second divided area DDM2 having a preset size in an arrangement direction of the touch node (TN(X(n−a), Y(m+a))) of the coordinate point (X(n−a), Y(m+a)), which is a preset second corner coordinate point.

In addition, the display driving circuit 400 may divide a third divided area DDM3 having a preset size in an arrangement direction of the touch node (TN(X(n−a), Y(n−a))) of the coordinate point (X(n−a), Y(n−a)), which is a preset third corner coordinate point, and divide a fourth divided area DDM4 having a preset size in an arrangement direction of the touch node (TN(X(m+a), Y(n−a))) of the coordinate point (X(m+a), Y(n−a)), which is a preset fourth corner coordinate point.

The display driving circuit 400 may divide a central area of the touch sensing area TSA into the central divided area SDM so as not to overlap the first to fourth divided areas DDM1 to DDM4.

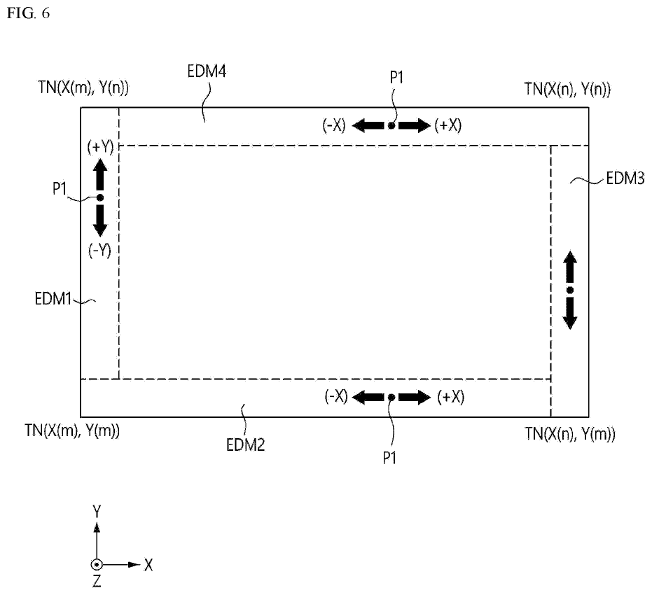

FIG. 6 is a block diagram illustrating a method of sensing one-touch movement in the peripheral areas illustrated in FIGS. 4 and 5.

Referring to FIG. 6, the touch driving circuit 200 supplies touch driving signals to the driving electrodes TE of the touch sensing area TSA, and measures charge change amounts of the touch nodes TN formed by the driving electrodes TE and the sensing electrodes RE. In addition, the touch driving circuit 200 calculates touch coordinates of the touch nodes TN where a touch is performed in real time according to a measurement result of the charge change amounts of the touch nodes TN, and transmits touch coordinate data including the touch coordinates to the display driving circuit 400.

The display driving circuit 400 compares the touch coordinates of the touch coordinate data which is input in real time from the touch driving circuit 200 with pre-stored arrangement coordinates of the touch nodes TN. In this case, the display driving circuit 400 compares the touch coordinates of the touch coordinate data which is input in real time with arrangement coordinates of the touch nodes TN pre-divided for each of the first to fourth peripheral areas EDM1 to EDM4, the first to fourth divided areas DDM1 to DDM4, and the central divided area SDM.

The display driving circuit 400 decides a touch occurrence position, a touch movement direction, and a movement distance for each of the first to fourth peripheral areas EDM1 to EDM4, the first to fourth divided areas DDM1 to DDM4, and the central divided area SDM according to a comparison result between the pre-divided arrangement coordinates of the touch nodes TN and the touch coordinates which are input in real time.

In an embodiment, as illustrated in FIG. 6, the display driving circuit 400 may decide a touch occurrence position P1 and a touch movement direction (e.g., a movement direction to an X-axis and a −X-axis or a Y-axis and a −Y-axis) for each of the first to fourth peripheral areas EDM1 to EDM4 according to the comparison result between the pre-divided arrangement coordinates of the touch nodes TN and the touch coordinates which are input in real time.

TABLE 1

| Sensing of touch movement | Display of screen menu |
|---|---|
| Sensing of touch in up and down | Display of contrast adjusting |
| directions in first peripheral area | icon |
| Sensing of touch in left and right | Display of brightness adjusting |
| directions in second peripheral area | icon |
| Sensing of touch in up and down | Display of volume adjusting |
| directions in third peripheral area | icon |
| Sensing of touch in left and right | Display of saturation adjusting |
| directions in fourth peripheral area | icon |

Referring to Table 1, the display driving circuit 400 may generate digital video data for controlling built-in functions preset to each correspond to a touch occurrence position P1 of one point and touch movement directions of the X-axis and the −X-axis or the Y-axis and the −Y-axis divided for each of the first to fourth peripheral areas EDM1 to EDM4.

In an embodiment, the display driving circuit 400 may generate digital video data so as to include an icon displaying a contrast control function of a display screen and display the digital video data as an image, when a touch occurrence position P1 of one point is detected in the first peripheral area EDM1 and the touch occurrence position P1 of the one point moves in Y-axis and −Y-axis directions (e.g., up and down directions) according to the comparison result between the arrangement coordinates of the touch nodes TN and the touch coordinates which are input in real time. The display driving circuit 400 may display the image while gradually changing a contrast of the image according to the touch occurrence position P1 of the one point, a movement direction, and a movement distance.

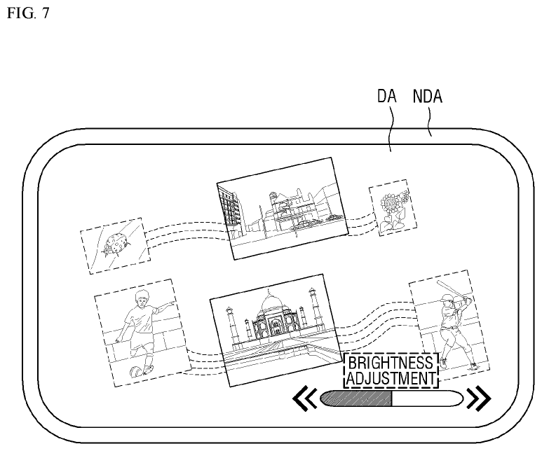

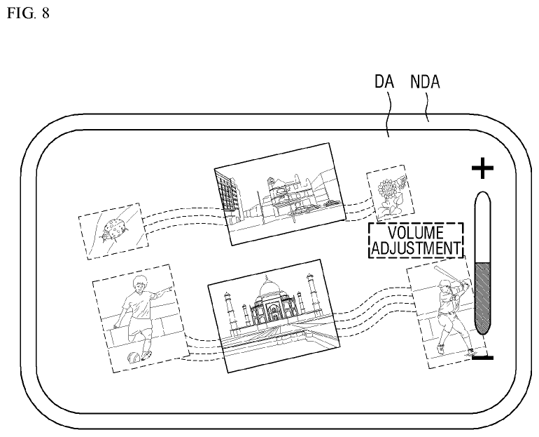

FIG. 7 is a schematic view of a first embodiment illustrating an icon display screen according to one-touch movement sensing in any one peripheral area illustrated in FIG. 6. In addition, FIG. 8 is a schematic view of a second embodiment illustrating an icon display screen according to one-touch movement sensing in any one peripheral area illustrated in FIG. 6.

Referring to Table 1 and FIG. 7, the display driving circuit 400 generates digital video data so as to include an icon displaying a brightness control function and displays the digital video data as an image, when a touch occurrence position P1 of one point is detected in the second peripheral area EDM2 and the touch occurrence position P1 of the one point moves in X-axis and −X-axis directions (e.g., left and right directions) according to the comparison result between the arrangement coordinates of the touch nodes TN and the touch coordinates which are input in real time. Therefore, the display driving circuit 400 may display the image while gradually changing a brightness of the image according to the touch occurrence position P1 of the one point, a movement direction, and a movement distance.

Referring to Table 1 and FIG. 8, the display driving circuit 400 generates digital video data so as to include an icon displaying a volume control function and displays the digital video data as an image, when a touch occurrence position P1 of one point is detected in the third peripheral area EDM3 and the touch occurrence position P1 of the one point moves in the Y-axis and −Y-axis directions (e.g., the up and down directions) according to the comparison result between the arrangement coordinates of the touch nodes TN and the touch coordinates which are input in real time. Therefore, the display driving circuit 400 may gradually change a volume of a volume speaker according to the touch occurrence position P1 of the one point, a movement direction, and a movement distance.

As illustrated in Table 1, the display driving circuit 400 may generate digital video data so as to include an icon displaying a saturation control function of the display screen and display the digital video data as an image, when a touch occurrence position P1 of one point is detected in the fourth peripheral area EDM4 and the touch occurrence position P1 of the one point moves in the X-axis and −X-axis directions (e.g., the left and right directions). The display driving circuit 400 may display the image while gradually changing a saturation of the image according to the touch occurrence position P1 of the one point, a movement direction, and a movement distance.

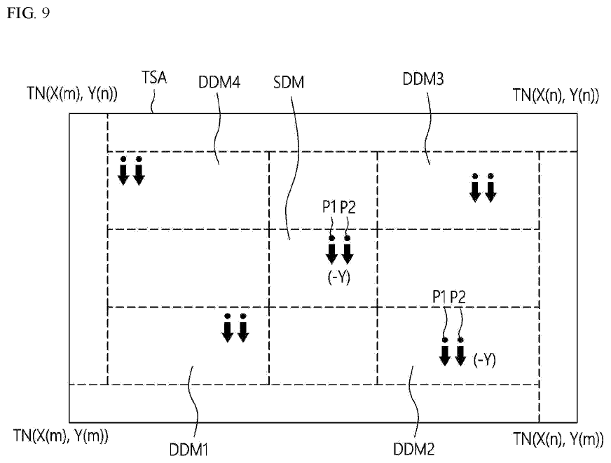

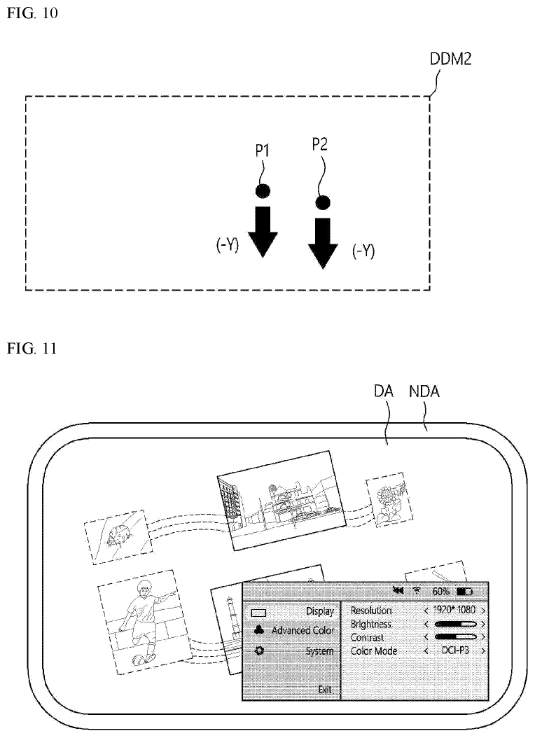

FIG. 9 is a block diagram illustrating a method of sensing one-touch movement in the divided areas and the central divided area illustrated in FIGS. 4 and 5. In addition, FIG. 10 is an enlarged block diagram illustrating a method of sensing one-touch movement in a second divided area illustrated in FIG. 9.

Referring to FIGS. 9 and 10, the touch driving circuit 200 supplies touch driving signals to the driving electrodes TE of the touch sensing area TSA, and measures charge change amounts of the touch nodes TN formed by the driving electrodes TE and the sensing electrodes RE. In this case, the touch driving circuit 200 calculates touch coordinates of two points for a plurality of touch nodes TN where touches have been performed, e.g., touch nodes TN of two points in real time according to a measurement result of the charge change amounts, and transmits touch coordinate data including the touch coordinates of the two points to the display driving circuit 400.

The display driving circuit 400 compares the touch coordinates of the touch coordinate data which is input in real time from the touch driving circuit 200 with pre-stored arrangement coordinates of the touch nodes TN. In this case, the display driving circuit 400 compares the touch coordinates of the touch coordinate data which is input in real time with arrangement coordinates of the touch nodes TN pre-divided for each of the first to fourth peripheral areas EDM1 to EDM4, the first to fourth divided areas DDM1 to DDM4, and the central divided area SDM.

The display driving circuit 400 decides touch occurrence positions and touch movement directions for each of the first to fourth peripheral areas EDM1 to EDM4, the first to fourth divided areas DDM1 to DDM4, and the central divided area SDM according to a comparison result between the pre-divided arrangement coordinates of the touch nodes TN and the touch coordinates of the two points which are input in real time.

In an embodiment, as illustrated in FIGS. 9 and 10, the display driving circuit 400 may decide touch occurrence positions P1 and P2 of two points and touch movement directions (e.g., the movement directions to the X-axis and −X-axis or the Y-axis and the −Y-axis) for each of the first to fourth divided areas DDM1 to DDM4 and the central divided area SDM according to the comparison result between the pre-divided arrangement coordinates of the touch nodes TN and the touch coordinates of the two points which are input in real time.

TABLE 2

| Sensing of touch movement | Display of screen menu |
|---|---|
| Sensing of movement of two points in | Display of screen adjusting |
| first divided area | menu bar |
| Sensing of movement of two points in | Display of contrast adjusting |
| second divided area | menu bar |
| Sensing of movement of two points in | Display of brightness adjusting |
| third divided area | menu bar |
| Sensing of movement of two points in | Display of resolution adjusting |
| fourth divided area | menu bar |
| Sensing of movement of two points in | Display of on/off menu bar |
| central divided area | |

Referring to Table 2, the display driving circuit 400 may generate digital video data for controlling built-in functions preset to each correspond to touch occurrence positions P1 and P2 of two points and touch movement directions of the X-axis and the −X-axis or the Y-axis and the −Y-axis divided for each of the first to fourth divided areas DDM1 to DDM4 and the central divided area SDM.

In an embodiment, the display driving circuit 400 may generate digital video data so as to include a screen adjusting menu bar and display the digital video data as an image, when touch occurrence positions P1 and P2 of two points are detected in the first divided area DDM1 and the touch occurrence positions P1 and P2 of the two points move in the Y-axis and −Y-axis directions (e.g., the up and down directions) according to the comparison result between the arrangement coordinates of the touch nodes TN and the touch coordinates which are input in real time. The display driving circuit 400 may display a selection screen of the screen adjusting menu bar according to the touch occurrence positions P1 and P2 of the two points, a movement direction, and a movement distance.

FIG. 11 is a schematic view of a third embodiment illustrating a menu bar display screen according to one-touch movement sensing in the second divided area illustrated in FIG. 10.

Referring to FIG. 11 together with Table 2, the display driving circuit 400 may generate digital video data so as to include a contrast adjusting menu bar and display the digital video data as an image, when touch occurrence positions P1 and P2 of two points are detected in the second divided area DDM2 and the touch occurrence positions P1 and P2 of the two points move in the Y-axis and −Y-axis directions (e.g., the up and down directions) according to the comparison result between the arrangement coordinates of the touch nodes TN and the touch coordinates which are input in real time. The display driving circuit 400 may display a selection screen of the contrast adjusting menu bar according to the touch occurrence positions P1 and P2 of the two points, a movement direction, and a movement distance.

The display driving circuit 400 may generate digital video data so as to include a brightness adjusting menu bar and display the digital video data as an image, when touch occurrence positions P1 and P2 of two points are detected in the third divided area DDM3 and the touch occurrence positions P1 and P2 of the two points move in the Y-axis and −Y-axis directions (e.g., the up and down directions) according to the comparison result between the arrangement coordinates of the touch nodes TN and the touch coordinates which are input in real time. The display driving circuit 400 may display a selection screen of the brightness adjusting menu bar according to the touch occurrence positions P1 and P2 of the two points, a movement direction, and a movement distance.

The display driving circuit 400 may generate digital video data so as to include a resolution adjusting menu bar and display the digital video data as an image, when touch occurrence positions P1 and P2 of two points are detected in the fourth divided area DDM4 and the touch occurrence positions P1 and P2 of the two points move in the Y-axis and −Y-axis directions (e.g., the up and down directions) according to the comparison result between the arrangement coordinates of the touch nodes TN and the touch coordinates which are input in real time. The display driving circuit 400 may display a selection screen of the resolution adjusting menu bar according to the touch occurrence positions P1 and P2 of the two points, a movement direction, and a movement distance.

The display driving circuit 400 may generate digital video data so as to include a screen on/off selection menu bar and display the digital video data as an image, when touch occurrence positions P1 and P2 of two points are detected in the central divided area SDM and the touch occurrence positions P1 and P2 of the two points move in the Y-axis and −Y-axis directions (e.g., the up and down directions) according to the comparison result between the arrangement coordinates of the touch nodes TN and the touch coordinates which are input in real time. The display driving circuit 400 may display a screen on/off selection screen according to the touch occurrence positions P1 and P2 of the two points, a movement direction, and a movement distance.

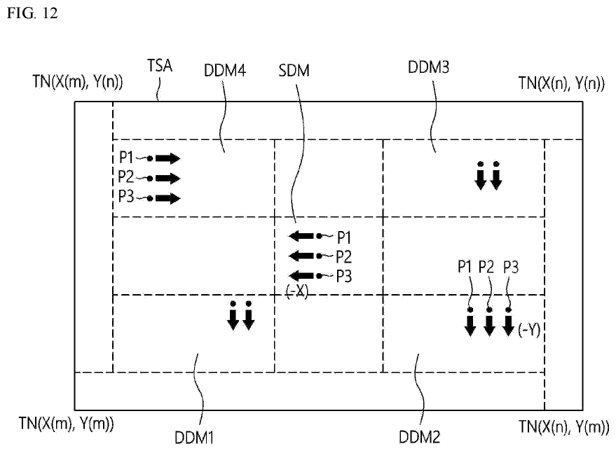

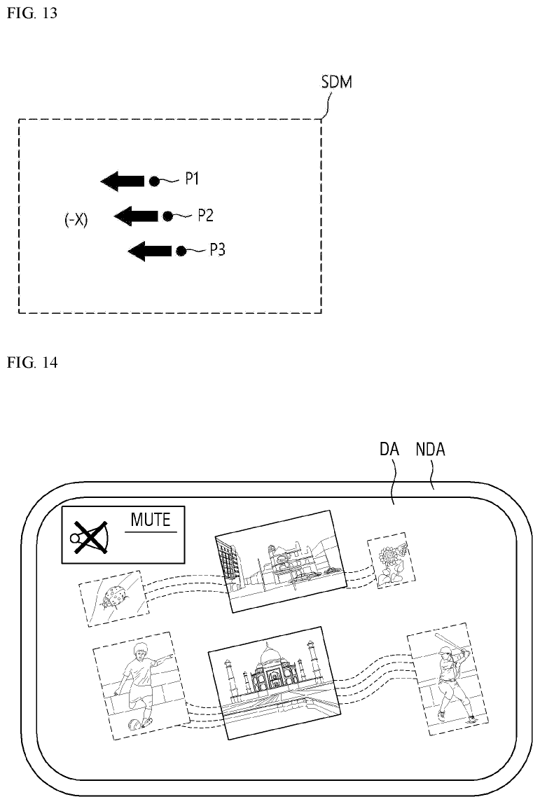

FIG. 12 is a block diagram of another embodiment illustrating a method of sensing one-touch movement in the divided areas and the central divided area illustrated in FIGS. 4 and 5. In addition, FIG. 13 is an enlarged block diagram illustrating a method of sensing one-touch movement in the central divided area illustrated in FIG. 12.

Referring to FIGS. 12 and 13, the display driving circuit 400 may decide touch occurrence positions and touch movement directions for each of the first to fourth peripheral areas EDM1 to EDM4, the first to fourth divided areas DDM1 to DDM4, and the central divided area SDM according to a comparison result between the pre-divided arrangement coordinates of the touch nodes TN and touch coordinates of three points which are input in real time.

In an embodiment, the display driving circuit 400 may decide touch occurrence positions P1, P2 and P3 of three points and touch movement directions (e.g., the movement directions to the X-axis and −X-axis or the Y-axis and the −Y-axis) for each of the first to fourth divided areas DDM1 to DDM4 and the central divided area SDM according to the comparison result between the pre-divided arrangement coordinates of the touch nodes TN and the touch coordinates of the three points which are input in real time.

TABLE 3

| Sensing of touch movement | Display of screen menu |
|---|---|
| Sensing of movement of three points in | Display of mode selection icon |
| first divided area | |
| Sensing of movement of three points in | Display of mute selection icon |
| second divided area | |
| Sensing of movement of three points in | Display of battery state of |
| central divided area | charge (“SoC”) |

Referring to Table 3, the display driving circuit 400 may generate digital video data for controlling built-in functions preset to each correspond to touch occurrence positions P1, P2, and P3 of three points and touch movement directions of the X-axis and the −X-axis or the Y-axis and the −Y-axis divided for each of the first to fourth divided areas DDM1 to DDM4 and the central divided area SDM.

In an embodiment, the display driving circuit 400 may generate digital video data so as to include an image display mode selection icon and display the digital video data as an image, when touch occurrence positions P1, P2, and P3 of three points are detected in the first divided area DDM1 and the touch occurrence positions P1, P2, and P3 of the three points move in the X-axis and −X-axis directions (e.g., the left and right directions) according to the comparison result between the arrangement coordinates of the touch nodes TN and the touch coordinates which are input in real time. The display driving circuit 400 may display the image display mode selection icon according to the touch occurrence positions P1, P2, and P3 of the three points, a movement direction, and a movement distance.

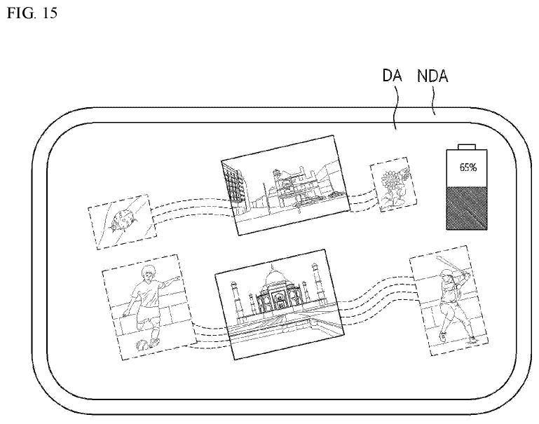

FIG. 14 is a schematic view of a fourth embodiment illustrating an icon display screen according to one-touch movement sensing in the second divided area illustrated in FIG. 13.

Referring to Table 3 and FIGS. 12 and 14, the display driving circuit 400 may generate digital video data so as to include a mute selection icon and display the digital video data as an image, when touch occurrence positions P1, P2, and P3 of three points are detected in the second divided area DDM2 and the touch occurrence positions P1, P2, and P3 of the three points move in the Y-axis and −Y-axis directions (e.g., the up and down directions) according to the comparison result between the arrangement coordinates of the touch nodes TN and the touch coordinates which are input in real time. The display driving circuit 400 may display a mute function selection icon and a mute state according to the touch occurrence positions P1, P2, and P3 of the three points, a movement direction, and a movement distance.

FIG. 15 is a schematic view of a fifth embodiment illustrating an icon display screen according to one-touch movement sensing in the central divided area illustrated in FIG. 13. Referring to Table 3 and FIGS. 13 and 15, the display driving circuit 400 may generate digital video data so as to include a battery SOC display icon and display the digital video data as an image, when touch occurrence positions P1, P2, and P3 of three points are detected in the central divided area SDM and the touch occurrence positions P1, P2, and P3 of the three points move in the X-axis and −X-axis directions (e.g., the left and right directions) according to the comparison result between the arrangement coordinates of the touch nodes TN and the touch coordinates which are input in real time. The display driving circuit 400 may display battery SoC information or the like according to the touch occurrence positions P1, P2, and P3 of the three points, a movement direction, and a movement distance.

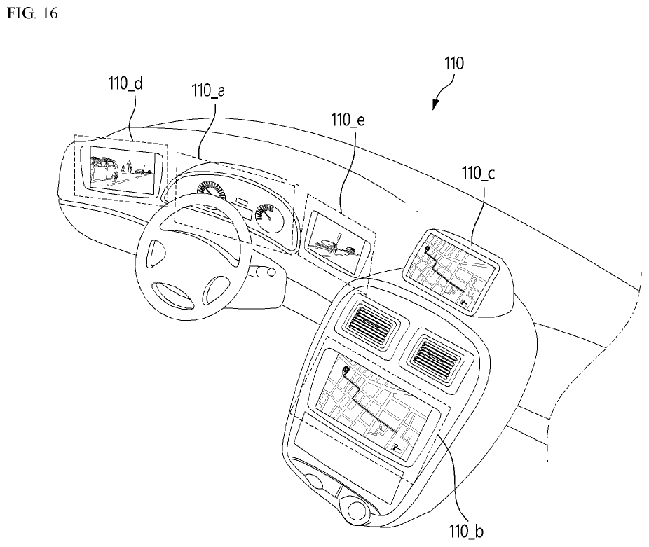

FIG. 16 is an illustrative view illustrating an embodiment of an instrument board and a center fascia of a vehicle including the portable display device according to the disclosure.

Referring to FIG. 16, the display device 110 including the display panel 100 according to the disclosure may be applied to an instrument board 110_a of the vehicle, be applied to a center fascia 110_b of the vehicle, or be applied to a center information display (“CID”) 110_c disposed on a dashboard of the vehicle. In addition, the display devices in an embodiment may be applied to room mirror displays 110_d and 110_e substituting for side-view mirrors of the vehicle, a navigation device, or the like.

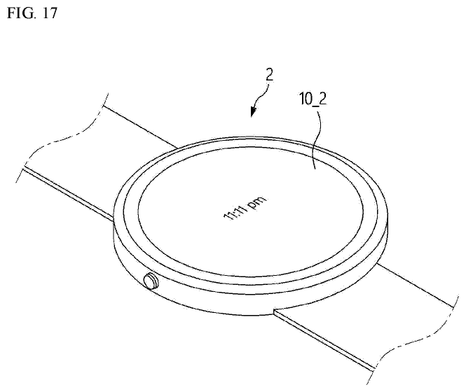

FIG. 17 is an illustrative view illustrating an embodiment of a watch-type smart device including the portable display device according to the disclosure.

Referring to FIG. 17, the display device 10 including the display panel 100 according to the disclosure may be applied to a watch-type smart device 2 as a position screen display 10_2 or the like. As such, the display device 10 including the display panel 100 according to the disclosure may be applied as an image display or the like of a health care device formed to be worn on the body or a biometric information measuring device.

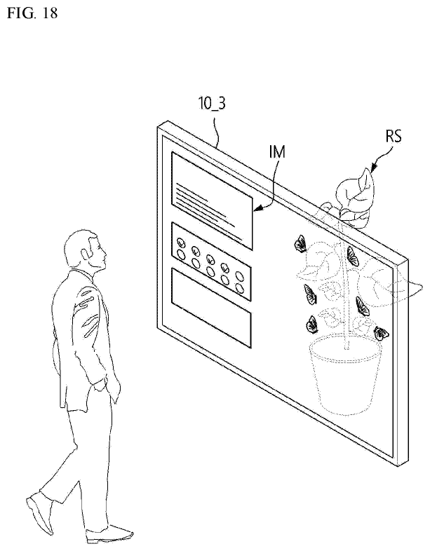

FIG. 18 is an illustrative view illustrating an embodiment of a transparent display device including the portable display device according to the disclosure.

Referring to FIG. 18, the display device 10 including the display panel 100 according to the disclosure may be applied to a transparent display device. The transparent display device may transmit light therethrough while displaying an image IM. Therefore, a user disposed on a front surface of the transparent display device may not only view the image IM displayed on the display panel 100, but also see an object RS or a background disposed on a rear surface of the transparent display device. When the portable display device 10 including the display panel 100 is applied to the transparent display device, the display panel 100 of the display device may include a light-transmitting part capable of transmitting light or may include or consist of a material capable of transmitting light.

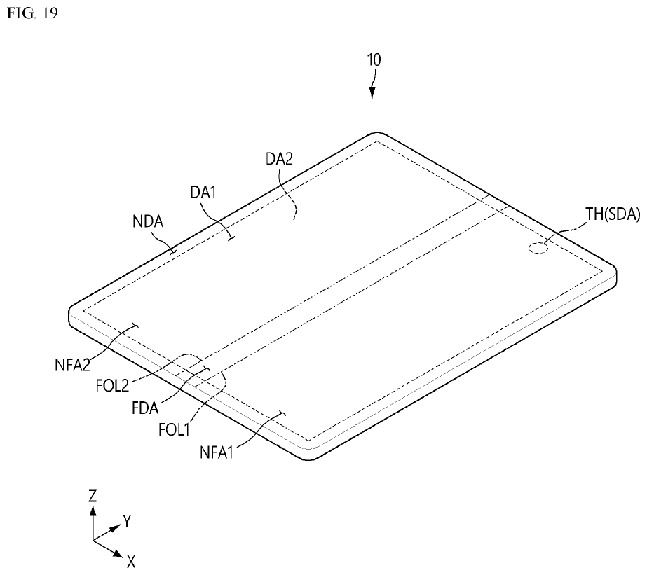

FIG. 19 is a perspective view illustrating an embodiment of a foldable smart device including the portable display device according to the disclosure.

It has been illustrated in FIG. 19 that the portable display device 10 is a foldable display device folded in the X-axis direction. The foldable and portable display device 10 may be maintained in both a folded state and an unfolded state. The display device 10 may be folded in an in-folding manner in which a front surface thereof is disposed inside. When the foldable and portable display device 10 is bent or folded in the in-folding manner, front surfaces of the foldable and portable display device 10 may be disposed to face each other. In an alternative embodiment, the foldable and portable display device 10 may be folded in an out-folding manner in which a front surface thereof is disposed outside. When the foldable and portable display device 10 is bent or folded in the out-folding manner, rear surfaces of the foldable and portable display device 10 may be disposed to face each other.

A first non-folding area NFA1 may be disposed on one side, e.g., the right side of a folding area FDA. A second non-folding area NFA2 may be disposed on an opposite side, e.g., on the left side of the folding area FDA. The touch sensors TSU in an embodiment of the disclosure may be formed and disposed on the first non-folding area NFA1 and the second non-folding area NFA2, respectively.

A first folding line FOL1 and a second folding line FOL2 may extend in the Y-axis direction, and the display device 10 may be folded in the X-axis direction. For this reason, a length of the display device 10 in the X-axis direction may be reduced by approximately half, and thus, a user may conveniently carry the display device 10.

An extension direction of the first folding line FOL1 and an extension direction of the second folding line FOL2 are not limited to the Y-axis direction. In an embodiment, the first folding line FOL1 and the second folding line FOL2 may extend in the X-axis direction, and the display device 10 may be folded in the Y-axis direction, for example. In this case, a length of the display device 10 in the Y-axis direction may be reduced by approximately half. In an alternative embodiment, the first folding line FOL1 and the second folding line FOL2 may extend in a diagonal direction of the display device 10 corresponding to a direction between the X-axis direction and the Y-axis direction. In this case, the display device 10 may be folded in a triangular shape.

When the first folding line FOL1 and the second folding line FOL2 extend in the Y-axis direction, a length of the folding area FDA in the X-axis direction may be smaller than a length of the folding area FDA in the Y-axis direction. In addition, a length of the first non-folding area NFA1 in the X-axis direction may be greater than the length of the folding area FDA in the X-axis direction. A length of the second non-folding area NFA2 in the X-axis direction may be greater than the length of the folding area FDA in the X-axis direction.

A first display area DA1 may be disposed on a front surface of the display device 10. The first display area DA1 may overlap the folding area FDA, the first non-folding area NFA1, and the second non-folding area NFA2. Therefore, when the display device 10 is unfolded, an image may be displayed in a front surface direction in the folding area FDA, the first non-folding area NFA1, and the second non-folding area NFA2 of the display device 10.

A second display area DA2 may be disposed on a rear surface of the display device 10. The second display area DA2 may overlap the second non-folding area NFA2. Therefore, when the display device 10 is folded, an image may be displayed in a front surface direction in the second non-folding area NFA2 of the display device 10.

It has been illustrated in FIG. 19 that a through hole TH in which a camera SDA or the like is formed is disposed in the first non-folding area NFA1, but the disclosure is not limited thereto. The through hole TH or the camera SDA may be disposed in the second non-folding area NFA2 or the folding area FDA.

In concluding the detailed description, those skilled in the art will appreciate that many variations and modifications may be made to the preferred embodiments without substantially departing from the principles of the disclosure. Therefore, the disclosed preferred embodiments of the disclosure are used in a generic and descriptive sense only and not for purposes of limitation.

What is claimed is:

1. A portable display device comprising:
a display panel which displays an image with pixels of a display area:
a touch sensor disposed in a front surface direction of the display area and a non-display area of the display panel:
a touch driving circuit which drives touch electrodes of the touch sensor, detects a touch occurrence position of at least one point, a touch movement direction, and a movement distance and generates touch coordinate data according to a detection result; and
a display driving circuit which displays an icon or a menu bar in the display area so that a user controls a screen control function and an operation control function of the display panel according to the touch occurrence position of the at least one point, the touch movement direction, and the movement distance.

2. The portable display device of claim 1, wherein the display driving circuit:
divides a touch sensing area of the touch sensor into a plurality of peripheral areas, a plurality of divided areas, and a central divided area based on arrangement coordinates of touch nodes arranged in a matrix form in the touch sensing area, and
compares touch coordinates of the touch coordinate data with the arrangement coordinates of the touch nodes and divides the touch occurrence position of the at least one point, the touch movement direction, and the movement distance for each of the plurality of peripheral areas, the plurality of divided areas, and the central divided area.

3. The portable display device of claim 2, wherein the display driving circuit:
generates digital video data including the icon or the menu bar by which the user confirms and controls at least one screen control function of brightness, chromaticity, resolution, and contrast control functions and at least one operation control function of volume, power, and mute control functions so that the at least one screen control function and the at least one operation control function correspond to the touch occurrence position of the at least one point, the touch movement direction, and the movement distance divided for each of the plurality of peripheral areas, the plurality of divided areas, and the central divided area, and
controls the screen control function or the operation control function according to the touch occurrence position of the at least one point, the touch movement direction, and the movement distance changed in real time.

4. The portable display device of claim 2, wherein the display driving circuit:
divides an area included in an arrangement range of a touch node of a coordinate point (X(m+a), Y(n)), a touch node of a coordinate point (X(m+a), Y(m+a)), and a touch node of a coordinate point (X(m), Y(m+a)) based on a touch node of a coordinate point (X(m), Y(n)) along an outer edge of the touch sensing area in one direction as a first peripheral area,
divides an area included in an arrangement range of the touch node of the coordinate point (X(m), Y(m+a)), a touch node of a coordinate point (X(n−a), Y(m+a)), and a touch node of a coordinate point (X(n−a), Y(m)) based on a touch node of a coordinate point (X(m), Y(m)) along an outer edge of the touch sensing area in a lower direction as a second peripheral area,
divides an area included in an arrangement range of the touch node of the coordinate point (X(n−a), Y(m)), a touch node of a coordinate point (X(n−a), Y(n−a)), and a touch node of a coordinate point (X(n), Y(n−a)) based on a touch node of a coordinate point (X(n), Y(m)) along an outer edge of the touch sensing area in another direction as a third peripheral area, and
divides an area included in an arrangement range of the touch node of the coordinate point (X(n), Y(n−a)), a touch node of a coordinate point (X(m+a), Y(n−a)), and the touch node of the coordinate point (X(m+a), Y(n)) based on a touch node of a coordinate point (X(n), Y(n)) along an outer edge of the touch sensing area in an upper direction as a fourth peripheral area,
the first to fourth peripheral areas are divided in a preset bezel area or an area corresponding to or overlapping the non-display area, and
m is 0 or a positive integer greater than 0, a is a positive integer greater than m, and n is a positive integer greater than a.

5. The portable display device of claim 2, wherein the display driving circuit:
divides first to fourth peripheral areas by dividing arrangement coordinates of the touch nodes each disposed in outer areas having a preset size in one direction, a lower direction, another direction, and an upper direction of the touch sensing area,
divides first to fourth divided areas in first to fourth corner directions according to arrangement positions of corner arrangement coordinates in four directions which do not overlap the first to fourth peripheral areas, and
divides a central area of the touch sensing area into the central divided area which does not overlap the first to fourth divided areas, and
the first to fourth peripheral areas are divided in a preset bezel area or an area corresponding to or overlapping the non-display area.

6. The portable display device of claim 5, wherein the display driving circuit decides the touch occurrence position, the touch movement direction, and the movement distance for each of the first to fourth peripheral areas, the first to fourth divided areas, and the central divided area according to a comparison result between divided arrangement coordinates of the touch nodes and the touch coordinates of the touch coordinate data which is input in real time.

7. The portable display device of claim 6, wherein the display driving circuit:
in a case in which a touch occurrence position of one point is detected in any one of the first to fourth peripheral areas and the touch occurrence position of the one point moves in preset Y-axis and −Y-axis directions or preset X-axis and −X-axis directions according to the comparison result between the arrangement coordinates of the touch nodes and the touch coordinates which are input in real time,
generates digital video data including an icon displaying any one screen control function selected among first to fourth screen control functions preset for each of the first to fourth peripheral areas and displays the digital video data as an image, and
executes a selected one screen control function according to the touch occurrence position of the one point, the touch movement direction, and the movement distance.

8. The portable display device of claim 6, wherein
in a case in which touch occurrence positions of two points are detected in any one of the first to fourth divided areas and the touch occurrence positions of the two points move in any one of Y-axis and −Y-axis directions and X-axis and −X-axis directions according to the comparison result between the arrangement coordinates of the touch nodes and the touch coordinates which are input in real time, the display driving circuit:
generates digital video data which includes a menu bar displaying any one operation control function selected among first to fourth operation control functions preset for each of the first to fourth divided areas and displays the digital video data as an image, and
executes a selected one operation control function according to the touch occurrence positions of the two points, the touch movement direction, and the movement distance.

9. The portable display device of claim 6, wherein in a case in which touch occurrence positions of two points are detected in the central divided area and the touch occurrence positions of the two points move in any one of Y-axis and −Y-axis directions and X-axis and −X-axis directions according to the comparison result between the arrangement coordinates of the touch nodes and the touch coordinates which are input in real time, the display driving circuit:
generates digital video data which includes a menu bar display a preset operation control function based on a two-point touch of the central divided area and displays the digital video data as an image, and
executes the preset operation control function based on the two-point touch of the central divided area according to the touch occurrence positions of the two points, the touch movement direction, and the movement distance.

10. The portable display device of claim 6, wherein in a case that touch occurrence positions of three points are detected in any one of the first to fourth divided areas and the touch occurrence positions of the three points move in any one of Y-axis and −Y-axis directions and X-axis and −X-axis directions according to the comparison result between the arrangement coordinates of the touch nodes and the touch coordinates which are input in real time, the display driving circuit:
generates digital video data which includes a menu bar displaying any one operation control function selected among fifth to eighth operation control functions preset for each of the first to fourth divided areas and displays the digital video data as an image, and
executes a selected one operation control function according to the touch occurrence positions of the three points, the touch movement direction, and the movement distance.

11. The portable display device of claim 6, wherein in a case that touch occurrence positions of three points are detected in the central divided area and the touch occurrence positions of the three points move in any one of Y-axis and −Y-axis directions and X-axis and −X-axis directions according to the comparison result between the arrangement coordinates of the touch nodes and the touch coordinates which are input in real time, the display driving circuit:
generates digital video data which includes a menu bar display a preset operation control function based on a three-point touch of the central divided area and displays the digital video data as an image, and
executes the preset operation control function based on the three-point touch of the central divided area according to the touch occurrence positions of the three points, the touch movement direction, and the movement distance.

12. A portable display device comprising:
a display panel which displays an image with pixels of a display area;
a touch sensor disposed in a front surface direction of the display area and a non-display area of the display panel so that the touch sensor corresponds to the display area and a preset partial area of the non-display area;
a touch driving circuit which drives touch electrodes of the touch sensor, detects a touch occurrence position of at least one point, a touch movement direction, and a movement distance and generates touch coordinate data according to a detection result; and
a display driving circuit which divides a touch sensing area of the touch sensor into a plurality of peripheral areas, a plurality of divided areas, and a central divided area based on arrangement coordinates of touch nodes arranged in the touch sensing area, decides a touch occurrence position of at least one point, a touch movement direction, and a movement distance for each of the plurality of peripheral areas, the plurality of divided areas, and the central divided area, and controls an image display screen of the display panel according to a decision result.

13. The portable display device of claim 12, wherein the display driving circuit compares touch coordinates of the touch coordinate data with the arrangement coordinates of the touch nodes and divides the touch occurrence position of the at least one point, the touch movement direction, and the movement distance for each of the plurality of peripheral areas, the plurality of divided areas, and the central divided area.

14. The portable display device of claim 13, wherein the display driving circuit:
generates digital video data including an icon or a menu bar so that a user confirms and controls at least one screen control function of brightness, chromaticity, resolution, and contrast control functions so as to correspond to the touch occurrence position of the at least one point, the touch movement direction, and the movement distance divided for each of the plurality of peripheral areas, the plurality of divided areas, and the central divided area,
generates digital video data including the icon or the menu bar so that the user confirms and controls at least one operation control function of volume, power, and mute control functions so as to correspond to the touch occurrence position of the at least one point, the touch movement direction, and the movement distance, and
controls the screen control function or the operation control function according to the touch occurrence position of the at least one point, the touch movement direction, and the movement distance changed in real time.

15. The portable display device of claim 13, wherein the display driving circuit:
divides first to fourth peripheral areas by dividing arrangement coordinates of the touch nodes each disposed in outer areas having a preset size in one direction, a lower direction, another direction, and an upper direction of the touch sensing area,
divides first to fourth divided areas in first to fourth corner directions according to arrangement positions of corner arrangement coordinates in four directions which do not overlap the first to fourth peripheral areas, and
divides a central area of the touch sensing area into the central divided area which does not overlap the first to fourth divided areas, and
the first to fourth peripheral areas are divided in a preset bezel area or an area corresponding to or overlapping the non-display area.

16. The portable display device of claim 15, wherein in a case in which a touch occurrence position of one point is detected in any one of the first to fourth peripheral areas and the touch occurrence position of the one point moves in preset Y-axis and −Y-axis directions or preset X-axis and −X-axis directions according to a comparison result between the arrangement coordinates of the touch nodes and the touch coordinates which are input in real time, the display driving circuit:
generates digital video data which includes an icon displaying any one screen control function selected among first to fourth screen control functions preset for each of the first to fourth peripheral areas and displays the digital video data as an image, and
executes a selected one screen control function according to the touch occurrence position of the one point, the touch movement direction, and the movement distance.

17. The portable display device of claim 15, wherein in a case in which touch occurrence positions of two points are detected in any one of the first to fourth divided areas and the touch occurrence positions of the two points move in any one of Y-axis and −Y-axis directions and X-axis and −X-axis directions according to a comparison result between the arrangement coordinates of the touch nodes and the touch coordinates which are input in real time, the display driving circuit:
generates digital video data which includes a menu bar displaying any one operation control function selected among first to fourth operation control functions preset for each of the first to fourth divided areas and displays the digital video data as an image, and
executes a selected one operation control function according to the touch occurrence positions of the two points, the touch movement direction, and the movement distance.

18. The portable display device of claim 15, wherein in a case in which touch occurrence positions of two points are detected in the central divided area and the touch occurrence positions of the two points move in any one of Y-axis and −Y-axis directions and X-axis and −X-axis directions according to a comparison result between the arrangement coordinates of the touch nodes and the touch coordinates which are input in real time, the display driving circuit:
generates digital video data which includes a menu bar display a preset operation control function based on a two-point touch of the central divided area and displays the digital video data as an image, and
executes the preset operation control function based on the two-point touch of the central divided area according to the touch occurrence positions of the two points, the touch movement direction, and the movement distance.

19. The portable display device of claim 15, wherein in a case in which touch occurrence positions of three points are detected in any one of the first to fourth divided areas and the touch occurrence positions of the three points move in any one of Y-axis and −Y-axis directions and X-axis and −X-axis directions according to a comparison result between the arrangement coordinates of the touch nodes and the touch coordinates which are input in real time, the display driving circuit:
generates digital video data as an image which includes a menu bar displaying any one operation control function selected among fifth to eighth operation control functions preset for each of the first to fourth divided areas and displays the digital video data as an image, and
executes a selected one operation control function according to the touch occurrence positions of the three points, the touch movement direction, and the movement distance.

20. The portable display device of claim 15, wherein in a case in which touch occurrence positions of three points are detected in the central divided area and the touch occurrence positions of the three points move in any one of Y-axis and −Y-axis directions and X-axis and −X-axis directions according to a comparison result between the arrangement coordinates of the touch nodes and the touch coordinates which are input in real time, the display driving circuit:
generates digital video data which includes a menu bar display a preset operation control function based on a three-point touch of the central divided area and displays the digital video data as an image, and
executes the preset operation control function based on the three-point touch of the central divided area according to the touch occurrence positions of the three points, the touch movement direction, and the movement distance.
